(19) United States
(12) Patent Application Publication
(10) Pub. No.: US 2002/0178995 A1
(43) Pub. Date: Dec. 5, 2002

(54) Universal boiling indicating pot cover

(76) Inventor: Walter J. Kane JR., Goodland, FL (US)

Correspondence Address: Edward M. Livingston, Esq., 628 Ellen Dr., P.O. Box 1599, Winter Park, FL, 32790, US

(21) Appl. No.: 09/837,590

(22) Filed: Apr. 18, 2001

(51) Int. Cl. A47J 27/212

(52) U.S. Cl. 116/67 R; 116/137 R; 126/388.1; 99/344

(57) ABSTRACT

A cover (1) for indicating when the boiling point of a liquid (7) in a pot (2) has been attained. A vent (4) in the cover emits a whistle when liquid begins to boil. The cover (1) is substantially circular and planar and having a diameter sufficient so that it rests on a wide size range of pots for universal use. A handle (9) with insulated covering (5) is provided for easy and safe removal of the cover.

### BACKGROUND OF THE INVENTION

This invention relates to cooking implements and more particularly to a cover designed to be placed over a wide range of sizes of pots and pans on a temporary basis to alert a person when the contents reach the boiling point.

The preparation of many foods, such as rice, eggs, potatoes and other fresh vegetables requires the boiling of water in a pot or pan which must be monitored carefully in order to insure proper results. If the liquid is not attended to at the point of boiling the water can boil away which may ruin the food and cookware or even set off fire and smoke alarms. Although there are certain pots and pans with custom fitting covers that emit audible sounds to indicate boiling, such as a pressure cooker, most pots and pans do not. Therefore, a need exists for a whistling cover that can be placed over any pot or pan on a temporary basis when bring water or other liquid to a boil.

The prior patented art includes many patented devices that have covers which emit audible whistles when the contents commence boiling, but none are like the present invention. For instance U.S. Pat. No. 2,536,369 issued to Hubbard on Jan. 2, 1951, disclose a pressure cooker having a cover with a handle and a vent that emits an audible whistle. U.S. Pat. No. 3,736,917 issued to Stepanek on Jun. 5, 1973, teaches a vent for a pan cover which is designed to pop-up and emit a whistle when a certain vapor pressure has been reached. U.S. Pat. No. 4,625,887 issued to Ito on Dec. 2, 1986, shows a sealed pan with a top cover having a steam escape valve which may emit a whistle. U.S. Pat. Nos. 4,548,156 and 4,586,455 issued to Shibata on Oct. 22, 1985 and May 6, 1986, respectively, show a lid knob for a pressure cooker containing a whistle which whistles when the contents boil. U.S. Pat. No. 4,690,095 issued to Walls, et al. on Sep. 1, 1987 teaches a knob for a pan which contains a rotary whistle activated by steam. U.S. Pat. No. 4,776,296 issued to Heermans on Oct. 11, 1988, shows another knob containing a whistling valve. U.S. Pat. No. 957,663 issued to Emslie on May 10, 1910, discloses a pan cover with a top that contains a pop-up whistling device. U.S. Pat. No. 4,193,166 issued to Neff on Mar. 18, 1980, shows a knob with a closeable vent. U.S. Pat. No. 4,823,980 issued to Ejiri on Apr. 25, 1989, shows a double wide pan which has a pop-up whistling device between the walls. Finally, U.S. Pat. No. 2,137,805 issued to Mueller on Nov. 22, 1938, shows a separate disk-shaped sound device in the bottom of the pan which rises to emit an audible whistle.

Although there are many devices in the prior art which contain whistling capabilities designed to alert a user when the contents of a pot or pan are boiling, all are cumbersome and none shows a universal, one size fits all, cover that can be placed over almost any size of pot or pan which emits a whistle when the boiling point is attained.

### SUMMARY OF THE INVENTION

The primary object of the present invention is to provide a temporary cover for pots and pans which indicates or alerts the user to when the boiling point has been attained.

Another object of the present invention is to provide such a cover that is universal in the sense that it fits nearly all sizes of pots and pans.

Another object of the present invention is to provide such a cover that has a handle for easy and safe removal of the cover upon reaching the boiling point.

An even further object of the present invention is to provide such a cover that saves energy by alerting the user immediately that the boiling point has been attained, thereby avoiding continuous boiling.

The present invention fulfills the above and other objects by providing a circular planar cover which has a diameter greater than the diameter of a top of a pot over which the cover is placed. The cover contains a vent which allows steam from the liquid in the pot to pass through so that it emits an audible whistle when the liquid reaches the boiling point. The cover has a handle extending to the edge of a cover, rather than a knob in the center, to keep the hand of the user away from boiling water and steam for easier and safer removal. The cover would preferably be no less than 10 inches or 25.5 centimeters in diameter to fit a wide range of sizes of pots and pans.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective view of the cover of the present invention in use on a pot;

FIG. 2 is a side cross-sectional view of the cover and pan of FIG. 1 along lines 2-2 of FIG. 1; and

FIG. 3 is a top view of the cover of the present invention by itself.

### DESCRIPTION OF THE PREFERRED EMBODIMENTS

For purposes of describing the preferred embodiment, the terminology used in reference to the numbered components in the drawings is as follows:

```
  1.  cover, generally
  2.  pot
  4.  whistling vent
  5.  insulated handle cover
  6.  cover circumference/edge
  7.  liquid
  8.  steam
  9.  metal handle extension
10.  circumference of pot
12.  pot handle
```

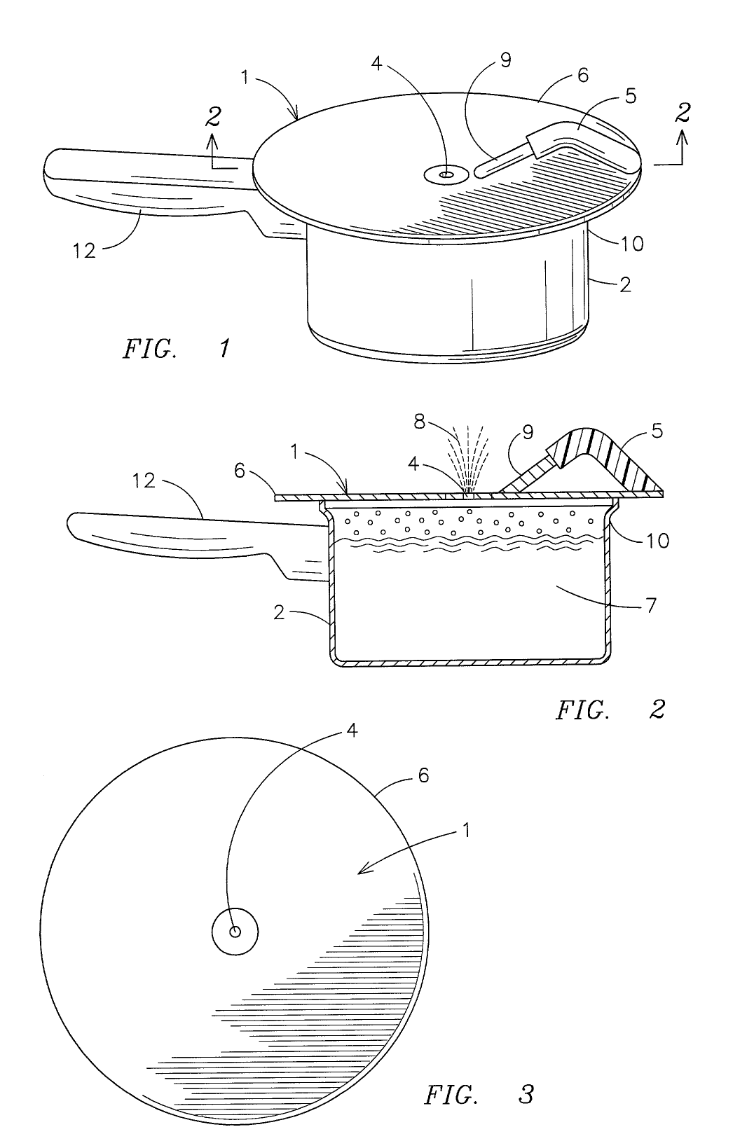

Discussing a preferred embodiment by reference to the drawings, in FIG. 1 the cover 1 is shown placed over a pot 2. The cover contains a small whistling vent 4 in the center. A handle 9 with insulated cover 5 extends from near the center of the cover 1 to the edge of the cover 6 so the cover can be safely and easily removed without burning the hand of the user. The diameter of the cover 1 is greater than that of the pot 2 so the circumference of the cover 6 is greater than the circumference of the pot 10. Thus, the cover 1 extends beyond the circumference of the pot 10.

In FIG. 2 the cover 1 is shown on a pot 2 which contains boiling liquid, such as water 7. At the boiling point the liquid 7 emits steam 8 through the vent 4 which creates an audible whistle, thereby alerting the user that boiling had commenced. Then the user can remove the cover 1 by use of the handle 5 or remove the pot 2 from the heating source by the pot handle 12 and then insert the food being prepared into the boiling water. Then the custom regular cover 1 can be placed on the pan 2 to complete the cooking process.

FIG. 3 shows the cover 1 without the handle 9 and cover 5 with the vent 4 placed in the center of the cover 1. The diameter of the cover 1 is anticipated to be at least 10 inches (25.5 centimeters) in order that the circumference of the cover 6 is greater than the circumference 10 of most pots and pans.

Thus, as described and illustrated, the present invention provides a temporary cover that is universal in nature as it can be used to cover nearly all sizes of pots and pans when boiling liquid is required and which emits an audible whistle to alert the user that the boiling point of liquid has been attained.

Although only a few embodiments of the present invention have been described in detail hereinabove, all improvements and modifications to this invention within the scope or equivalents of the claims are included as part of this invention.

Having thus described my invention, I claim:

1. A cover to indicate when a boiling point of liquid in a pot or pan has been attained, said cover comprising:
a substantially circular planar rigid piece of material having a diameter greater than a diameter of a top of a pot on which the cover is placed; and
a vent through the cover which allows vapor from boiling liquid to pass through so the cover emits an audible whistle when the liquid in the pot obtains the boiling point.

2. The cover of claim 1 having a handle extending to an outer edge of the cover for easy and safe removal.

3. The cover of claim 1 having a diameter of at least 10 inches (25.5 centimeters) so that it can be used to cover a wide range of sizes of pots and pans.
